(19) United States
(12) Patent Application Publication
(10) Pub. No.: US 2007/0062560 A1
(43) Pub. Date: Mar. 22, 2007

(54) PROCESS FOR CLEANING WAFERS IN AN IN-LINE CLEANING PROCESS

(76) Inventors: Tadahiro Imatani, Tokyo (JP); Eiichi Taniguchi, Tokyo (JP)

Correspondence Address: HAYES, SOLOWAY P.C., 3450 E. SUNRISE DRIVE, SUITE 140, TUCSON, AZ, 85718, US

(21) Appl. No.: 11/470,917

(22) Filed: Sep. 7, 2006

(30) Foreign Application Priority Data
Sep. 16, 2005 (JP) 2005-270048

(51) Int. Cl. C23G 1/00; B08B 3/00; B08B 7/00

(52) U.S. Cl. 134/2; 134/26; 134/33

(57) ABSTRACT

A wafer cleaning process includes the steps of supplying a cleaning liquid while rotating the wafer at a first rotational speed, supplying a rinsing liquid on the wafer at a second rotational speed substantially equal to the first rotational speed, supplying a rinsing liquid on the central area of the wafer while substantially stopping the wafer, and rotating the wafer at a fourth rotational speed higher than the first and second rotational speeds to scatter the stored rinsing liquid by a centrifugal force.

### BACKGROUND OF THE INVENTION

(a) Field of the Invention

The present invention relates to a process for cleaning wafers in an in-line cleaning process.

(b) Description of the Related Art

A wafer cleaning process used in a semiconductor manufacturing process is performed to remove residuals from the wafer surface and thereby prevent undesirable particles from being generated during later process steps or in the product semiconductor device. Along with development of smaller-dimension semiconductor devices, the pollution of semiconductor devices caused by particles increases the adverse influence on the product yield of the semiconductor devices. Thus, the wafer cleaning process attracts a larger attention in these days. The wafer cleaning process generally includes consecutive steps of cleaning the wafer surface by using a cleaning liquid, rinsing the wafer surface by using a rinsing liquid to remove the cleaning liquid, and drying the rinsed wafer surface.

In the manufacture of semiconductor devices, an in-line process is increasingly used in order for fabricating a variety of types of semiconductor devices. Among the in-line processes, an in in-line cleaning process is described in Patent Publication JP-2005-183937A. FIG. 9 shows the in-line wafer cleaning system described in the publication.

In the in-line cleaning process shown in FIG. 9, a wafer 11 is mounted on a horizontal wafer stage 12 and rotated around the center of the wafer 11. In a cleaning step, a cleaning liquid nozzle 15 disposed above the wafer 11 ejects a cleaning liquid 21 onto the center of the wafer surface. The cleaning liquid is driven by a centrifugal force toward the periphery of the wafer due to the rotation of the wafer 11, to chemically peel-off the residuals such as resist particles and thereby remove the residuals from the wafer surface. In a rinsing step, a rinsing liquid is supplied from a rinsing liquid nozzle 16 to remove the cleaning liquid together with the residuals from the wafer surface. In a drying step, the rotational speed of the wafer 11 is increased to thereby scatter the rinsing liquid toward outside of the wafer.

In the conventional in-line wafer cleaning process as described above, the cleaning liquid nozzle 15 may drop a liquid droplet onto the peripheral area of the wafer 11 after completion of the cleaning step due to miss-control of a valve for the nozzle 15, for example. If the droplet includes a significant volume of cleaning liquid, the cleaning liquid may not be removed in the subsequent rinsing step. The residual cleaning liquid may attach onto the wafer and later generate particles to cause pollution of the wafer surface.

The particles caused by the residual cleaning liquid may be avoided by a suitable control of the valve for the cleaning liquid. However, the valve may be deteriorated to have an inferior stopping function, and thereby drop such a droplet onto the wafer.

### SUMMARY OF THE INVENTION

In view of the above problem in the conventional in-line cleaning process, it is an object of the present invention to provide an in-line cleaning process which is capable of effectively removing the droplet of the cleaning liquid dropped onto the peripheral portion of the wafer.

The present invention provides a method for cleaning a wafer, including the steps of: supplying a cleaning liquid onto the wafer while rotating the wafer at a first rotational speed; supplying a rinsing liquid onto the wafer while rotating the wafer at a second rotational speed; supplying a rinsing liquid onto a central area of the wafer while stopping the wafer or rotating the wafer at a third rotational speed lower than the first and second rotational speeds, to store the supplied rinsing liquid on the central area; and rotating the wafer at a fourth rotational speed higher than the first and second rotational speeds to scatter the stored rinsing liquid toward outside of the wafer.

In accordance with the method of the present invention, the step of supplying the rinsing liquid onto the central area of the wafer stores a larger volume of rinsing liquid on the central area, and the subsequent step of rotating the wafer at the fourth rotational speed can scatter the larger volume of the rinsing liquid to thereby improve the rinsing efficiency. Thus, a semiconductor device substantially free from the residuals after the cleaning step can be obtained.

The above and other objects, features and advantages of the present invention will be more apparent from the following description, referring to the accompanying drawings.

### BRIEF DESCRIPTION OF THE DRAWINGS

FIG. 1 is a vertical sectional view of an in-line wafer cleaning system using a cleaning method according to a first embodiment of the present invention.

FIGS. 2A to 2D are sectional views of the in-line wafer cleaning system of FIG. 1 during consecutive steps of the cleaning process.

FIG. 3 is a flowchart of the cleaning process used in the wafer in-line cleaning system of FIG. 1.

FIG. 4 is a sectional view of the wafer for showing the behavior of the rinsing liquid stored on the central area of the wafer.

FIG. 5 is a sectional view of the in-line wafer cleaning system during ejection of the rinsing liquid.

FIG. 6 is a sectional view of the in-line wafer cleaning system during generation of mist in the vicinity of the wafer surface.

FIG. 7 is a sectional view of the conventional in-line wafer cleaning system during a drying step.

FIG. 8 is a graph showing the number of particles generated on the samples of wafer surface.

FIG. 9 is a sectional view of a conventional in-line wafer cleaning system.

### PREFERRED EMBODIMENT OF THE INVENTION

Now, the present invention is more specifically described with reference to accompanying drawings, wherein similar constituent elements are designated by similar reference numerals throughout the drawings.

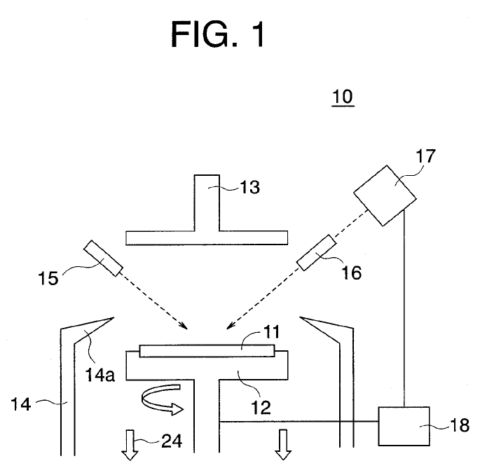

FIG. 1 shows an in-line wafer cleaning system using a wafer cleaning method according to a first embodiment of the present invention. The wafer cleaning system is used to remove polymer, for example, from the wafers one by one. The wafer cleaning system, generally designated by numeral 10, includes a wafer stage 12 for mounting thereon a wafer 11 to be cleaned, associated instrument such as nozzles 15, 16, a shield plate 13 disposed above the wafer stage 12, a guard wall 14 encircling the periphery of the wafer stage 12, sensors such as a ultra-sonic flow meter 17, and a control section including a rotational speed controller 18.

The wafer stage 12 has a protrusion on the periphery thereof for holding the wafer 11 at the periphery of the wafer 11. The wafer stage 12 is driven by a drive motor for rotation at a controlled rotational speed. The guard wall 14 encircles the wafer stage 12 and includes a pentroof 14a which protrudes from the top of the guard wall 14 toward the space above the wafer stage 12. The guard wall 14 is controlled for vertical movement thereof with respect to the wafer stage 12.

The cleaning liquid nozzle 15 and rinsing liquid nozzle 16 are disposed above the guard wall 14 and wafer stage 12 and apart from the wafer stage 12 as viewed in the vertical direction. The cleaning liquid nozzle 15 ejects a cleaning liquid therefrom toward the center of the wafer 11 mounted on the wafer stage 12. The rinsing liquid nozzle 16 ejects therefrom a rinsing liquid, such as pure water, toward the center of the wafer 11 at a flow rate of 2 litters/minute. The shield plate 13 is disposed above the ejection port of the cleaning liquid nozzle 15 and rinsing liquid nozzle 16.

All the wafer stage 12, shield plate 13, guard wall 14, cleaning liquid nozzle 15 and rinsing liquid nozzle 16 are installed in a cleaning tank or container not shown. An exhausting system not shown is disposed between the wafer stage 12 and the guard wall 14 at the bottom of the container for exhausting the gas including mist in the container along the direction of arrow 24.

The ultrasonic flow meter 17 is disposed at the rear side of the rinsing liquid nozzle 16 as viewed from the wafer stage 12. The ultrasonic flow meter 17 includes therein a ultrasonic transmitter and a ultrasonic receiver, which are disposed on the surface of a tube through which the rinsing liquid is supplied toward the ejection port of the rinsing liquid nozzle 16. The principle of the ultrasonic flow meter 17 is such that the rinsing liquid flowing through the tube generates a time interval between the transmission and the reception of the ultrasonic wave depending on the flow rate of the rinsing liquid. The ultrasonic flow meter 17 measures an accurate flow rate based on the time interval, and also measures a flow volume of the rinsing liquid ejected from the rinsing liquid nozzle 16 during a specified time interval.

The rotational speed controller 18 measures the rotational speed of the wafer stage 12 and receives the flow volume of the rinsing liquid measured by the ultrasonic flow meter 17, to control the rotational speed of the wafer stage 12.

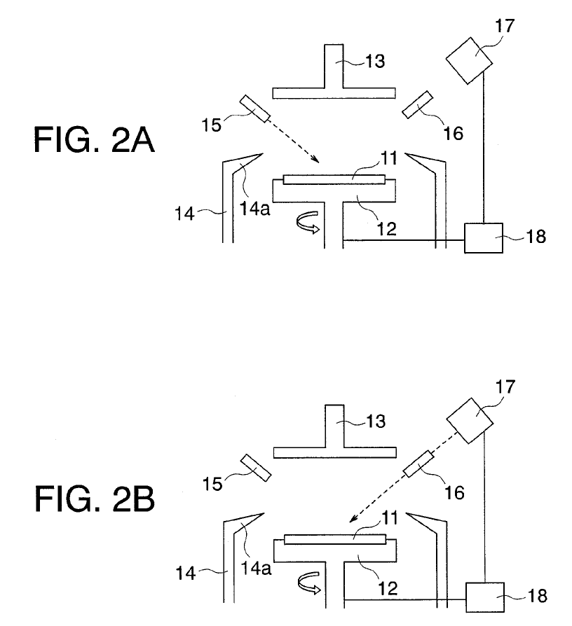

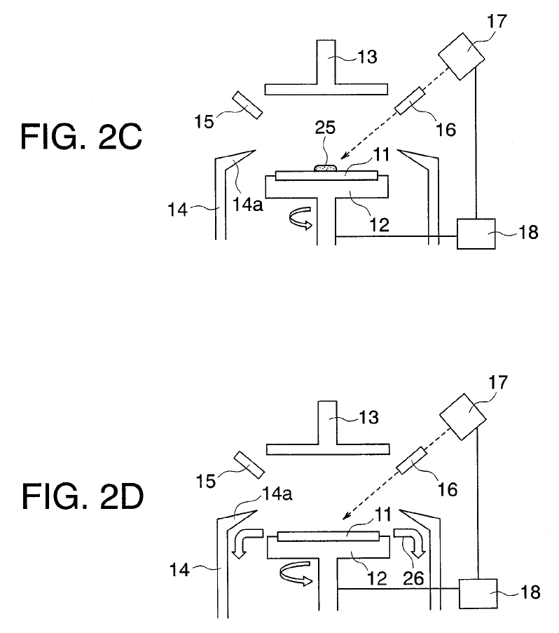

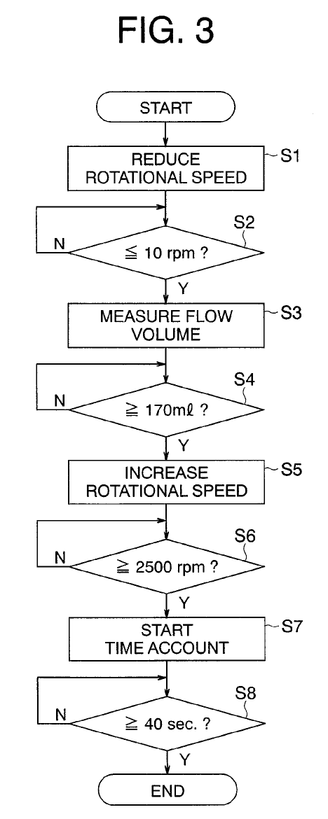

FIGS. 2A to 2D consecutively show operation of the in-line wafer cleaning system of FIG. 1. After the wafer 11 is mounted on the wafer stage 12, a cleaning step is conducted by rotating the wafer stage 12 at 120 revolutions per minute (rpm) and ejecting the cleaning liquid toward the center of the wafer 11 from the cleaning liquid nozzle 15, as shown in FIG. 2A. The cleaning step is performed for 40 seconds. In this step, the guard wall 14 is maintained at a vertical position so that the pentroof 14a is higher than the wafer surface. This vertical position of the guard wall 14 is referred to as a discharging position at which the exhausting system is operated to exhaust the waste liquid and the gas from the container.

Thereafter, a normal rinsing step is conducted by rotating the wafer stage 12 at 120 rpm similarly to the cleaning step and ejecting the rinsing liquid toward the center of the wafer 11 from the rinsing liquid nozzle 16, as shown in FIG. 2B. The rinsing step is conducted for 40 seconds, and the guard wall 14 is maintained the discharging position similarly to the cleaning step. After a time length of 40 seconds is elapsed, the rotational speed of the wafer stage 12 is gradually lowered.

Thereafter a rinsing liquid storing step is conducted for storing the rinsing liquid on the wafer 11. The rinsing liquid storing step is such that the rinsing liquid is ejected from the rinsing liquid nozzle 16 and the rotational speed of the wafer stage 12 is lowered down to 10 rpm or lower, thereby storing the rinsing liquid 25 on the central area of the wafer 11, as shown in FIG. 2C. The rotational speed controller 18 maintains the lowered rotational speed for a time length needed for storing a specific volume of the rinsing liquid.

Thereafter, a drying step is conducted by raising the rotational speed of the wafer stage at 2500 rpm or above. A larger centrifugal force generated by the larger rotational speed scatters the rinsing liquid 25 stored on the central area toward outside of the wafer 11, as shown in FIG. 2D, to remove the remaining particles and cleaning liquid. This drying step is conducted for a specific time length. In the drying step, the guard wall 14 is maintained at the exhausting position similarly to the other preceding steps. The rinsing liquid ejected from the surface of the wafer 11 is guided by the pentroof 14a of the guard wall 14 toward the bottom the container, and exhausted by the exhaust system.

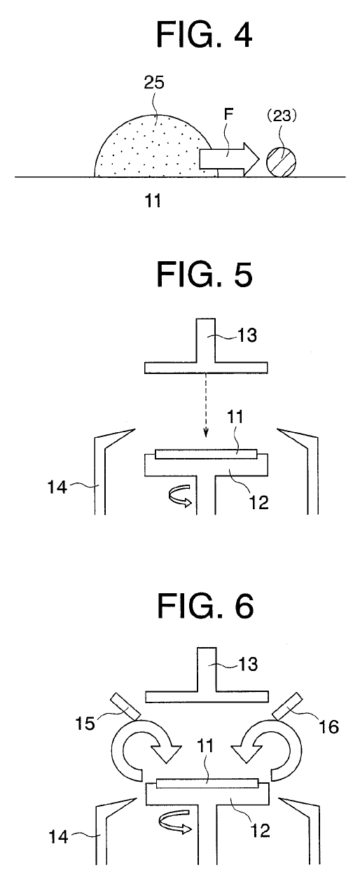

FIG. 4 is a flowchart showing the procedure of the rinsing liquid storing step in the wafer cleaning system of FIG. 1. After the normal rinsing step is finished, the rotational speed controller 18 lowers the rotational speed of the wafer stage (step S1), and monitors the rotational speed. If the rotational speed is lowered down to 10 rpm (step S2), the rotational speed controller 18 instructs the ultrasonic flow meter 17 to measure the flow volume of the rinsing liquid ejected from the rinsing liquid nozzle 16 (step S3). The ultrasonic flow meter 16 starts measurement of the flow volume of the ejected rinsing liquid, and transmits the current flow volume of the ejected rinsing liquid.

The rotational speed controller 18 monitors the current flow volume of the ejected rinsing liquid transmitted from the ultrasonic flow meter. If the current flow volume exceeds 170 milliliters (ml) at step S4, the rotational speed controller 18 instructs the drive motor of the wafer stage 12 to raise the rotational speed up to 2500 rpm (step S5). The time length between the start of calculation of the flow volume and the count up to 170 ml is approximately 5 seconds.

If the rotational speed of the wafer stage reaches 2500 rpm (step S6), the process shifts to the drying step whereby the time length elapsed from the start of drying step is measured (step S7). If the rotational speed controller 18 fails to detect the flow volume reaching the specific setting within a specific time length, the rotational speed controller 18 generates an alarm to inform the operator of this failure. If a time length of 40 seconds is elapsed from the start of the drying step (step S9), the drying step is finished.

FIG. 5 shows behavior of the rinsing liquid stored on the central area of the wafer surface. Rotation of the wafer stage at a higher rotational speed generates a centrifugal force, F=mr ω², on the stored rinsing liquid 25, given m, r and ω being the mass of the rinsing liquid stored, the distance measured from the center of the wafer, and the angular velocity of the wafer, respectively.

The increase of the rotational speed increases the centrifugal force in proportion to the rotational speed. The specified volume of rinsing liquid stored on the central area of the wafer surface increases the function of rinsing on the wafer surface in the drying step. Thus, the droplet of cleaning liquid dropped on the peripheral area of the wafer surface can be effectively removed in the drying step.

In the rinsing liquid storing step, the flow volume of the rinsing liquid is measured by the ultrasonic flow meter 17 with a higher accuracy. This allows the rinsing liquid to be stored in an accurate amount thereof, thereby achieving a stable rinsing effect.

In the present embodiment, the volume of rinsing liquid stored on the central area of the wafer surface in the rinsing liquid storing step is set 170 ml and the rotational speed of the wafer stage is set at 2500 rpm in the drying step. This provides a suitable centrifugal force applied onto the rinsing liquid stored, thereby achieving a suitable rinsing effect on the droplet of the cleaning liquid on the peripheral area of the wafer. The rotational speed of 0 to 10 rpm of the wafer in the rinsing liquid storing step well reduces the centrifugal force applied onto the rinsing liquid stored on the central area of the wafer, thereby providing a suitable volume of the stored rinsing liquid.

A first comparative example for comparing therewith the wafer cleaning process of the present embodiment was conducted, wherein the rinsing liquid is supplied onto the wafer surface in the rinsing step in the manner as shown in FIG. 6. More specifically, in the first comparative example, the rinsing liquid was ejected vertically in the rinsing step from the center of the shield plate 13 onto the center of the wafer 11. Since the rinsing liquid supplied in the first comparative example was not applied with a sufficient centrifugal force due to a smaller volume of the rinsing liquid, the rinsing step revealed insufficient rinsing capability especially in the central area of the wafer, and left the residual rinsing liquid and cleaning liquid on the central area of the wafer 11.

In the first comparative example, the residual rinsing liquid and cleaning liquid left on the central area of the wafer was attached as a residual film after the completion of the drying step. The residual film was peeled-off from the wafer surface to generate undesirable particles on the wafer. On the other hand, in the present embodiment, the rinsing liquid nozzle 16 disposed apart from the wafer 11, as viewed from the vertical direction, provided a slanted flow of the ejected rinsing liquid, thereby achieving a higher rinsing effect onto the central area of the wafer. Thus, the process of the present embodiment effectively prevented generation of particles in the wafer.

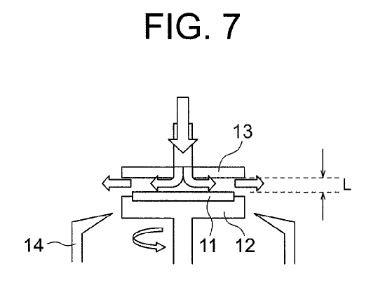

A second comparative example for comparing therewith the cleaning process of the present embodiment was conducted by disposing the guard wall 14 so that the pentroof 14a of the guard wall was lower than the wafer surface, as shown in FIG. 7. This position of the guard wall 14 is generally referred to as a delivery position at which the cleaned wafer is replaced by another wafer delivered from outside the wafer cleaning system. In the second comparative example, mist of the cleaning liquid or rinsing liquid was generated due to the high rotational speed of the wafer and stayed in the vicinity of the wafer surface. The mist was left on the wafer surface after the rinsing and drying steps, to generate particles in the later step. On the other hand, in the present embodiment, the pentroof 14a of the guard wall 14 disposed higher than the wafer surface prevented the mist of liquid from returning onto the wafer surface, whereby the mist was exhausted by the exhaust system from the container.

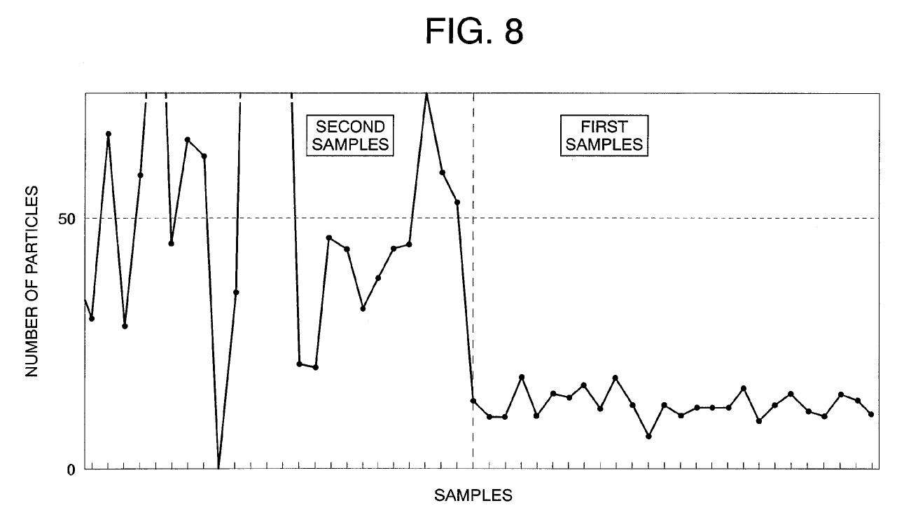

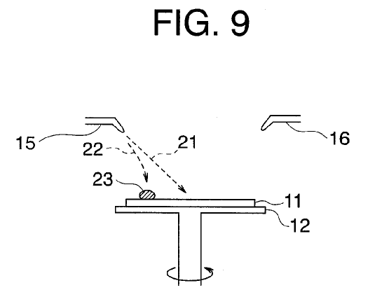

In order for assuring the advantages of the present embodiment, a plurality of wafers were subjected to the cleaning process of the above embodiment, and are hereinafter referred to as first examples. A third comparative example for comparing therewith the cleaning process of the present embodiment was conducted to clean a plurality of wafers, which are hereinafter referred to as second examples. The third comparative example is such that the rinsing liquid is ejected in the manner shown in FIG. 6, the rinsing liquid storing step is not conducted, and the shield plate 13 is disposed in the drying step in the close vicinity of the wafer surface so that the distance “L” between the wafer surface and the shield plate 13 is 2.5 mm, as shown in FIG. 8. The rinsing liquid is supplied from the center of the shield plate 13, which allows omission of the rinsing liquid nozzle 16 above the wafer surface, thereby allowing such a small distance “L”. In addition, the guard wall 14 is disposed in the delivery position, and N₂ gas is ejected from the center of the shield plate in the drying step for removing the mist.

The first and second samples were subjected to the wafer test as to whether or not the samples had a particle having a diameter of 0.16 μm or above, and the sample having at least 50 of such particles was regarded a failed sample. Finally, the number of failed samples is counted among the first samples and among the second samples. The test revealed that the first samples included no failed sample, and that the second samples included 27% failed samples among the total second samples. This shows the advantage of the present embodiment over the third comparative example in that the present embodiment can reduce a significant number of particles generated in the wafer cleaning process.

It is to be noted that the first rotational speed in the cleaning step may be equal to or different from the second rotational speed in the normal rinsing step. The third rotational speed in the additional rinsing step may be preferably 0 to 10 rpm for sufficiently reducing or negating the centrifugal force applied to the stored rinsing liquid.

The additional rinsing step may preferably store 170 ml or above of the rinsing liquid on the central area of the wafer. The fourth rotational speed in the drying step may be preferably equal to or above 700 rpm. A higher rotational speed provides a larger centrifugal force to the stored rinsing liquid.

The rinsing liquid nozzle should preferably be disposed above the wafer surface while being apart from the central area of the wafer as viewed in the vertical direction. This provides a higher rinsing efficiency at the central area of the wafer to prevent the cleaning liquid from being left on the central area.

The step of rotating the wafer at the fourth rotational speed should be conducted while encircling the wafer by the guard wall to exhaust the mist including the rinsing liquid at the bottom of the container. The normal rinsing step and the additional rinsing step may use the same rinsing liquid or different rinsing liquids.

Since the above embodiments are described only for examples, the present invention is not limited to the above embodiments and various modifications or alterations can be easily made therefrom by those skilled in the art without departing from the scope of the present invention.

What is claimed is:

1. A method for cleaning a wafer, comprising the steps of:
supplying a cleaning liquid onto the wafer while rotating the wafer at a first rotational speed;
supplying a rinsing liquid onto the wafer while rotating the wafer at a second rotational speed;
supplying a rinsing liquid onto a central area of the wafer while stopping the wafer or rotating the wafer at a third rotational speed lower than said first and second rotational speeds, to store said supplied rinsing liquid on the central area; and
rotating the wafer at a fourth rotational speed higher than said first and second rotational speeds to scatter the stored rinsing liquid toward outside of the wafer.

2. The method according to claim 1, wherein said first rotational speed is substantially equal to said second rotational speed.

3. The method according to claim 1, wherein said third rotational speed is 0 to 10 revolutions per minute.

4. The method according to claim 1, wherein the step of supplying the rinsing liquid onto the central area stores the rinsing liquid in a volume of 170 milliliters or above.

5. The method according to claim 1, wherein said fourth rotational speed is equal to or above 700 revolutions per minute.

6. The method according to claim 1, wherein the step of supplying the rinsing liquid supplies the rinsing liquid from a nozzle disposed above the wafer and apart from the central area of the wafer as viewed in the vertical direction.

7. The method according to claim 1, wherein the step of rotating the wafer at the fourth rotational speed is conducted while encircling the periphery of the wafer and exhausting gas including mist of the rinsing liquid.
